(19) United States
(12) Patent Application Publication
(10) Pub. No.: US 2008/0082631 A1
(43) Pub. Date: Apr. 3, 2008

(54) Inter Application User Interface Integration in Element Management Systems

(75) Inventors: Aravindan Rajoo, Sreamwood, IL (US); Swarnalatha Murthy, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/536,801

(22) Filed: Sep. 29, 2006

(51) Int. Cl. G06F 15/16

(52) U.S. Cl. 709/219

(57) ABSTRACT

Disclosed are a method and wireless device for automating an application client associated with an application server. The method includes transmitting via a controller module (120) and automation launch request (204) to an application server (130). The application server (130) resides on an information processing system (106). The automation launch request (204) is for, among other things, initiating an application client (124) associated with the application server (130). At least an authorization is received to initiate the application client (124) from the application server (130). The application client (124) is initiated via an automation control request (206).

### FIELD OF THE INVENTION

The present invention generally relates to the field of element management systems, and more particularly relates to automating control of an element management system application client.

### BACKGROUND OF THE INVENTION

The number of elements in communication and computing networks has drastically increased in size in recent years. As the number of network elements and the types of networks increased, managing these networks manually became inefficient. Therefore, automated network management systems were created. Network management systems (“NMS”) generally include a combination of hardware and software for monitoring and administering a network. In telecommunication networks such as a wireless communication network, each network element (“NE”) (e.g., telecommunication hardware) is managed by an element management system (“EMS”).

The NMS manages a network as a whole, while an element management system (“EMS”) manages each network element individually. For example, an NMS manages the communication between the network elements and an EMS allows an administrator or user to manage the features of a network element. An EMS communicates with an NMS for support in managing traffic between itself and its managed network elements. A northbound interface can be used to provide communications between the NMS and EMS. The northbound interface enables management automation so that a user can control network elements from an NMS interface.

However, higher level NMSs that integrate with an EMS via its northbound interface typically extract and display only general purpose information. In order for specific device information to be displayed by the NMS custom software development is required. This generally requires rewriting graphical user interface (“GUI”) screens that already exists within the EMS. Furthermore, traditional northbound interfaces provide access to data only via Corba, SNMP, SOAP, etc. The NMS is responsible for developing custom GUI screens to represent the information being extracted from the EMS.

Existing technologies for inter-application integration utilize proprietary technology such as Microsoft's COM Architecture/OLE Automation, and thus limit the platforms that can be integrated. Additionally, existing inter-application integration approaches require that the application being automated be pre-installed on the client machine.

Therefore a need exists to overcome the problems with the prior art as discussed above.

### SUMMARY OF THE INVENTION

Briefly, in accordance with the present invention, disclosed are a method and wireless device for automating an application client associated with an application server. The method includes transmitting via a controller module an automation launch request to an application server. The application server resides on an information processing system. The automation launch request is for, among other things, initiating an application client associated with the application server. At least an authorization is received to initiate the application client from the application server. The application client is initiated via an automation control request.

In another embodiment, a method for automating an application client associated with an application server is disclosed. The method includes transmitting, via a controller module, an automation launch request comprising a first network language protocol to an application server. The application server resides on an information processing system. The automation launch request is for initiating an application client associated with the application server. At least an authorization to initiate the application client is received from the application server. The application client is initiated via an automation control request comprising a second network language protocol.

In yet another embodiment, a wireless communication device for automating an application client associated with an application server is disclosed. The wireless communication device includes a memory and a processor communicatively coupled to the memory. A controller module is communicatively coupled to the memory and the processor. The controller module is for transmitting an automation launch request to an application server. The application server resides on an information processing system. The automation launch request is for, among other things, initiating an application client associated with the application server. At least an authorization is received to initiate the application client from the application server. The application client is initiated via an automation control request.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a wireless communication system according to an embodiment of the present invention;

FIG. 2 is a block diagram illustrating a more detailed view of the system components in the wireless communication system of FIG. 1;

FIG. 3 is a block diagram illustrating a wireless communication device according to an embodiment of the present invention;

FIG. 4 is a block diagram illustrating an information processing system according to an embodiment of the present invention; and

FIG. 5 is an operational flow diagram illustrating a process of providing automated control of an application client according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting, but rather to provide an understandable description of the invention.

One advantage of the embodiments of the present invention is that an application client associated with an application server can be automated. For example, if a network management system detects an issue with a network element, the network management system GUI automatically launches an element management system GUI on a user device. The user device is able to reuse the GUIs already created by the element management system. Another advantage is that embodiments of the present invention provide a controller module that can be implemented in any language/platform and an application client that is not dependent upon the platform of the controller module.

Wireless Communications System

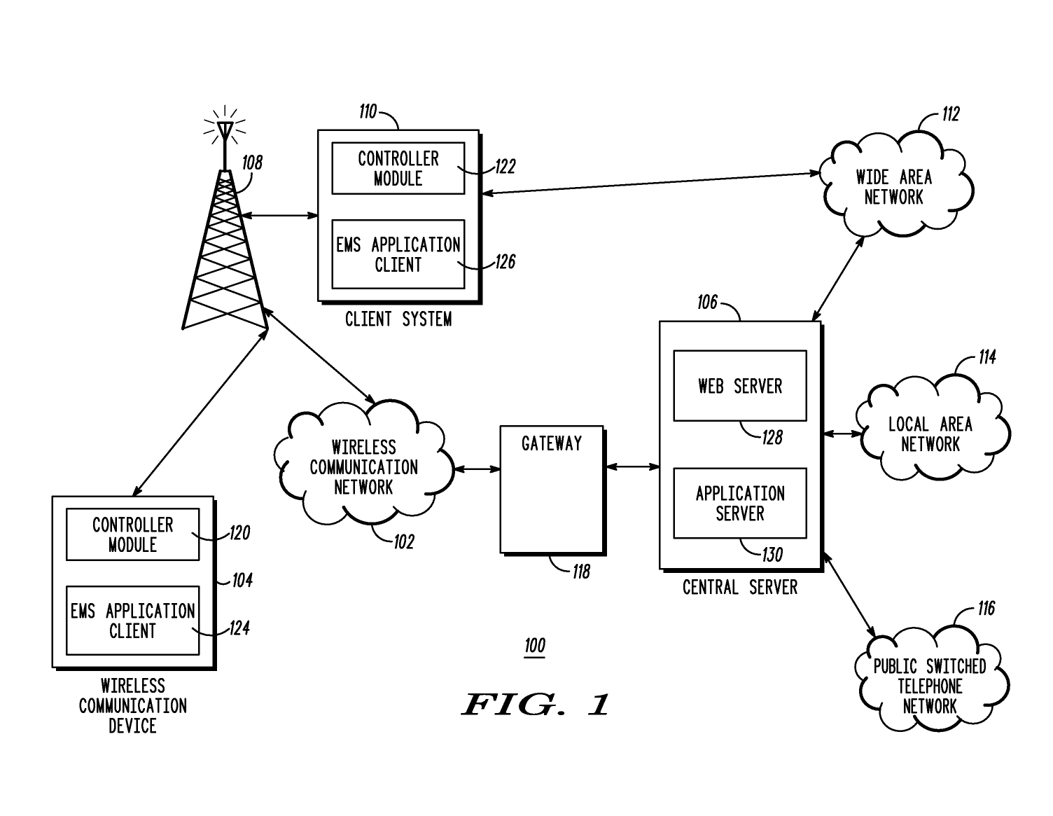

A wireless communications system 100 according to an embodiment of the present invention is shown in FIG. 1. As shown, a wireless communications network 102 connects one or more wireless communication devices 104 to a central server 106. The wireless communications network 102 comprises a wireless network such as a mobile phone network, a mobile text messaging device network, a pager network, or the like. Further, the communications standard of the wireless communications network 102 of the embodiments of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA), Orthogonal Frequency Division Multiplexing (OFDM), or the like. Additionally, the wireless communications network 102 also comprises text messaging standards, for example, Short Message Service (SMS), Enhanced Messaging Service (EMS), Multimedia Messaging Service (MMS), or the like. In one embodiment, the wireless communications network 102 is capable of broadband wireless communications such as an 802.16 WiMax system.

The wireless network 102 supports any number of wireless communication devices 104. The support of the wireless network 102 includes support for mobile telephones, smart phones, text messaging devices, handheld computers, wireless communication cards, pagers, beepers, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities. In one embodiment, wireless communications network 102 allows for mesh networking between the wireless devices 104.

The wireless communications system 100 also includes one or more base stations 108. The base station 108, in this embodiment, includes a base station controller. The wireless communication device 104, in this embodiment, is communicatively coupled to the wireless communications network 102 via the base station 108. The wireless communication system 100, in this embodiment, also includes one or more information processing systems 110. The information processing system 110, in this embodiment, is a personal computer, workstation, personal digital assistant, or the like. The information processing system 110 can be communicatively coupled to the wireless communications network 102 via a wireless communications card, a wide area network 112 such as the Internet, or a local area network 114.

The wireless communications system 100 also includes a central server 106, which is communicatively coupled to the wireless communication network 102 via a gateway 118. The central server 106, in this embodiment, maintains and processes information for all wireless devices 104 communicating on the wireless network 102. Additionally, the central server 106 communicatively couples wireless communications devices 104 to a wide area network 112, a local area network 114, and a public switched telephone network 116 through the wireless communications network 102. Each of these networks has the capability of sending data, for example, a multimedia text message, to the wireless device 104.

The wireless communication device 104 and the information processing system 110, in this embodiment, each include a respective controller module 120, 122 and a respective application client 124, 126. Each controller module 120, 122 enables automated control of the corresponding application client 124, 126 to an application server. In this embodiment each controller module 120, 122 can be an NMS client and each application client 124, 126 can be an EMS application client. The controller modules 120, 122 and the application clients 124, 126 are discussed in greater detail below.

Throughout this embodiment the present invention is discussed with respect to NMS and EMS. However, the present invention is not limited to only an NMS and EMS application. For example, instead of an NMS controller, a Customer Relationship Management controller, a Billing and Provisioning System controller, an Issue/Trouble/Support Ticketing System controller, and the like can be used. Additionally, instead of an EMS system, the present invention can be directed towards a Factory/Process Automation/Monitoring System coupled with a higher level Monitoring System. A Time Entry System for Resource Tracking coupled with an overall Project Management System is another example.

The central server 106, in this embodiment, comprises a web server 128 and an application server 130. The web server 128 is for receiving automation launch requests from the controller modules 120, 122 in the wireless communication device 104 and/or the information processing system 110. The automation launch requests are discussed in greater detail below. The application server 130, which in this embodiment is an EMS application server, communicates with the wireless communication device 104 and the information processing system 110 via the web server 128. The application server 130 provides the application client 120 and 122 to the requesting devices 104 and 110. The application server 130 is discussed in greater detail below. In some embodiments, the application server 130 can include the web server 128. Further, at least one of the web server 128 and the application server 130 can reside on a remote information processing system.

System Overview

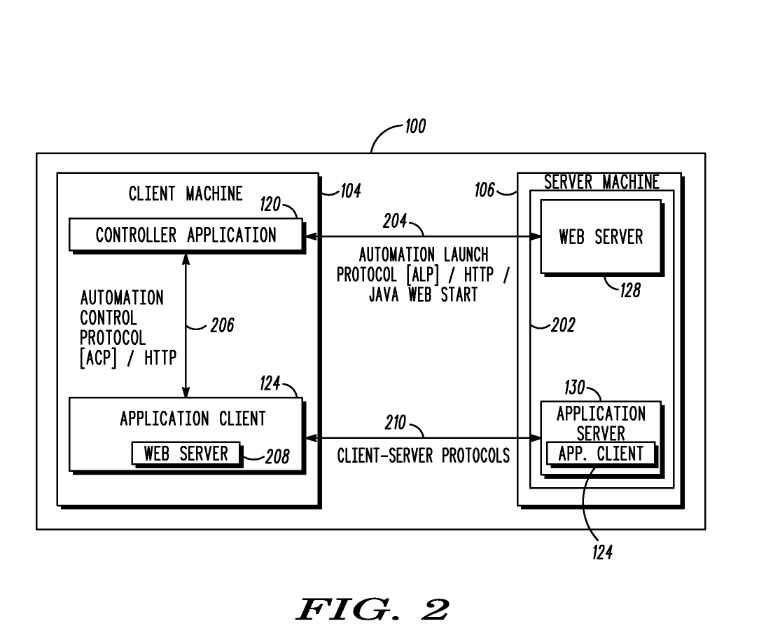

FIG. 2 is a block diagram showing a more detailed view of the wireless communication device 104 and the central server 106 of FIG. 1. The following discussion is analogously applicable to the information processing system 110. FIG. 2 omits various components shown in FIG. 1 such as the wireless network 102 for purposes of clarity.

FIG. 2 shows a client machine such as the wireless communication device 104 communicatively coupled to the central server 106. The client machine includes the controller module 120 communicatively coupled to the application client 124 via an automation control protocol (“ACP”) 206. In this embodiment, the controller module is an NMS controller application and the application client is an EMS application client that includes a web server 208. The ACP, in this embodiment, can be automation requests packaged in a hyper text transfer protocol (“HTTP”) packet. The central server 106 includes an EMS 202 comprising the web server 128 and the application server 130. FIG. 2 shows the central server 106 as also including the application client 124. This is to illustrate that the application client 124 is requested from the central server and downloaded onto the wireless communication device 104. The controller module 120 communicates with the web server 128 of the central server 106 via an automation launch protocol (“ALP”) 204. The ALP, in this embodiment, can utilize various platforms such as HTTP and Java Web Start. The application client 124, when installed on the wireless communication device 104, communicates with the application server 130 through the application client web server 208 using standard client-server protocols 210.

In this exemplary embodiment, the wireless communication device 104 interfaces with an NMS that collects data via a Northbound Interface for an EMS 202. Here, the NMS detects an issue with a network element such as a router, gateway 118, or the like. The NMS controller application 120 allows the user of the wireless communication device 104 to interact with the EMS 202 via the controller application 120. In one embodiment, the controller application 120 and the application client 124 are implemented using different platforms. When the NMS controller application detects a problem with a network element, it determines whether the EMS application client 124 is installed on the device 104. If the application client 124 has not already been installed on the device 104, the controller module 120 sends a request to the web server 128 to download the application client 124. The request, in this embodiment, is sent via a network protocol language such as a hyper text transfer protocol (“HTTP”) request. In other words, the controller module 120 launches the application client 124 from the application server 130 via an automation launch request 204, which can be an HTTP request.

However, the present invention is not limited to HTTP requests. The application client 124 can be a program based on a different platform than the controller module 120. For example, the controller module 120 can request the application client 124 via HTTP requests and the application client 124 can be a Java Web Start application. The application client 124, in this embodiment, provides a graphical user interface to a user for interacting with the application server 130. The graphical user interface, in this embodiment, is already rendered by the EMS 202 and is reused by the application client 124. This allows the application client to interact with the EMS 202.

The controller module 120, in this embodiment, automates the application client 124 via automation control requests 206. The automation control requests 206, in this embodiment, are a network protocol language request such as an HTTP request. Screens on the application client 124 can be automated by the control module 120 to display specific screens, reports, and the like via the automation control requests 206. The application client 124 communicates with the application server 124 via client-server protocols 210. In this embodiment, the automation launch requests 204 sent by the controller module 120 include user identifiable information for authorizing the user and local port information for automation control information 206.

Therefore, the present invention provides for the automation of an application client associated with an application server. For example, if a network management system detects an issue with a network element, the controller module 202 (e.g., an NMS controller module in this example) provides an NMS GUI to a user that automatically launches an element management system GUI on the user device. The user device is able to reuse the GUIs already created by the EMS. The present invention also allows the controller module 120 to be implemented in any language/platform and the application client 124 to be independent of the controller module's platform.

Wireless Communication Device

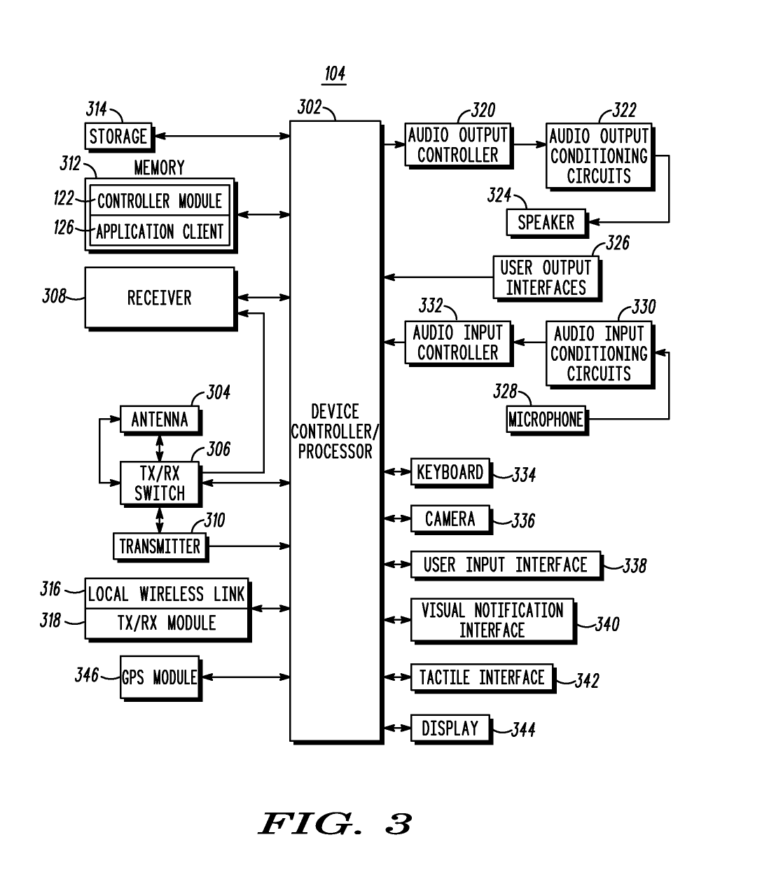

FIG. 3 is a block diagram illustrating a detailed view of a wireless communication device 104 according to an embodiment of the present invention. FIG. 3 illustrates only one example of a wireless communication device. Other wireless communication devices such as wireless communication air interface cards are also compatible with the present invention and comprise many of the same components that are discussed below. The wireless communication device 104 of FIG. 3 operates under the control of a device controller/processor 302, that controls the sending and receiving of wireless communication signals. In receive mode, the device controller 302 electrically couples an antenna 304 through a transmit/receive switch 306 to a receiver 308. The receiver 308 decodes the received signals and provides those decoded signals to the device controller 302.

In transmit mode, the device controller 302 electrically couples the antenna 304, through the transmit/receive switch 306, to a transmitter 310. The device controller 302 operates the transmitter and receiver according to instructions stored in the memory 312. These instructions include, for example, a neighbor cell measurement-scheduling algorithm. The memory 312 also includes the controller module 120 and the application client 124. These components perform and interact as discussed above with respect to FIG. 3. Although shown as residing in the memory 312, one or more of these components can be implemented in hardware within the wireless communication device 304.

The wireless communication device 304 also includes non-volatile storage memory 314 for storing, for example, an application waiting to be executed on the wireless communication device 104. The wireless communication device 104, in this example, also includes an optional local wireless link 316 that allows the wireless communication device 104 to directly communicate with another wireless device without using a wireless network. The optional local wireless link 316, for example, is provided by Bluetooth, Infrared Data Access (IrDA) technologies, or the like. The optional local wireless link 316 also includes a local wireless link transmit/receive module 318 that allows the wireless device 104 to directly communicate with another wireless communication device such as wireless communication devices communicatively coupled to personal computers, workstations, and the like.

The wireless communication device 104 of FIG. 3 further includes an audio output controller 320 that receives decoded audio output signals from the receiver 808 or the local wireless link transmit/receive module 318. The audio controller 320 sends the received decoded audio signals to the audio output conditioning circuits 322 that perform various conditioning functions. For example, the audio output conditioning circuits 322 may reduce noise or amplify the signal. A speaker 324 receives the conditioned audio signals and provides audio output for listening by a user. The audio output controller 320, audio output conditioning circuits 322, and the speaker 324 also allow for an audible alert to be generated to notify the user of a missed call, received messages, or the like. The wireless communication device 104 further includes additional user output interfaces 326, for example, a headphone jack or a hands-free speaker.

The wireless communication device 104 also includes a microphone 328 for allowing a user to input audio signals into the wireless communication device 104. Sound waves are received by the microphone 128 and are converted into an electrical audio signal. Audio input conditioning circuits 330 receive the audio signal and perform various conditioning functions on the audio signal, for example, noise reduction. An audio input controller 332 receives the conditioned audio signal and sends a representation of the audio signal to the device controller 302.

The wireless communication device 104 also comprises a keyboard 334 for allowing a user to enter information into the wireless communication device 104. The wireless communication device 104 further comprises a camera 336 for allowing a user to capture still images or video images into memory 312. Furthermore, the wireless communication device 104 includes additional user input interfaces 338, for example, touch screen technology, a joystick, or a scroll wheel. In this embodiment, a peripheral interface is also included for allowing the connection of a data cable to the wireless communication device 104. In such an embodiment of the present invention, the connection of a data cable allows the wireless communication device 104 to be connected to a computer or a printer.

A visual notification (or indication) interface 340 is also included on the wireless communication device 104 for rendering a visual notification (or visual indication), for example, a sequence of colored lights on the display 344 or one or more LEDs, to the user of the wireless communication device 104. For example, a received multimedia message may include a sequence of colored lights to be displayed to the user as part of the message. Alternatively, the visual notification interface 340 can be used as an alert by displaying a sequence of colored lights or a single flashing light on the display 344 or LED when the wireless communication device 104 receives a message, or the user missed a call.

The wireless communication device 104 also includes a tactile interface 342 for delivering a vibrating media component, tactile alert, or the like. For example, a multimedia message received by the wireless communication device 104, may include a video media component that provides a vibration during playback of the multimedia message. The tactile interface 342, in this embodiment, is used during a silent mode of the wireless communication device 104 to alert the user to an incoming call or message, missed call, or the like. The tactile interface 342 allows this vibration to occur, for example, through a vibrating motor or the like.

The wireless communication device 104 also includes an optional Global Positioning System (GPS) module 346. The optional GPS module 348 determines the location and/or velocity information of the wireless communication device 104. This module 346 uses the GPS satellite system to determine the location and/or velocity of the wireless communication device 104. Alternatively, the wireless communication device 104 may include alternative modules for determining the location and/or velocity of wireless communication device 104, for example, using cell tower triangulation or assisted GPS.

Information Processing System

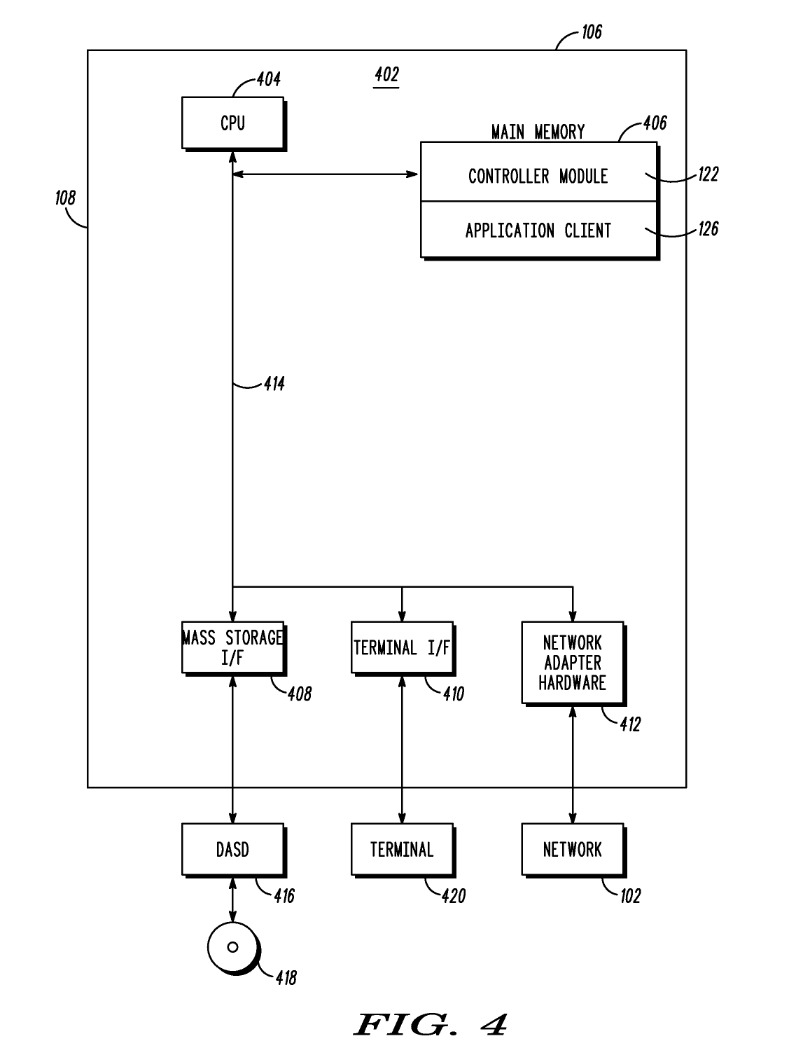

FIG. 4 is a block diagram illustrating a detailed view of the client system 110 according to an embodiment of the present invention. The client system 110, in this embodiment, is based upon a suitably configured information processing system adapted to implement the client system 110 according to this exemplary embodiment of the present invention. Any suitably configured processing system is similarly able to be used as the client system 110 in further embodiments of the present invention (for example, a personal computer, workstation, or the like).

The client system 110 includes a computer 402. The computer 402 has a processor 404 that is communicatively connected to a main memory 406 (e.g., volatile memory), a non-volatile storage interface 408, a terminal interface 410, and a network adapter hardware 412. A system bus 414 interconnects these system components. The non-volatile storage interface 408 is used to connect mass storage devices, such as data storage device 416, to the gateway. One specific type of data storage device is a computer readable medium such as a CD drive, which may be used to store data to and read data from a CD or DVD 418 or floppy diskette. Another type of data storage device is a hard disk configured to support, for example, NTFS type file system operations.

The main memory 406, in this embodiment, includes controller module 122 and the application client 126. These components perform and interact similar to the controller module 120 and application client 124 of the wireless communication device 104 as discussed above with respect to FIG. 2. Although shown as residing in the memory 406, one or more of these components can be implemented as hardware within the client system 110 in further embodiments.

Although illustrated as concurrently resident in the main memory 406, it is clear that respective components of the main memory 406 are not required to be completely resident in the main memory 406 at all times or even at the same time. In this embodiment, the client system 110 utilizes conventional virtual addressing mechanisms to allow programs to behave as if they have access to a large, single storage entity, referred to herein as a computer system memory, instead of access to multiple, smaller storage entities such as the main memory 406 and data storage device 416. The term “computer system memory” is used herein to generically refer to the entire virtual memory of the client system 110.

Although only one CPU 404 is illustrated for computer 402, computer systems with multiple CPUs can be used equally effectively. Embodiments of the present invention can further incorporate interfaces that each include separate, fully programmed microprocessors that are used to off-load processing from the CPU 404. Terminal interface 410 is used to directly connect one or more terminals 420 to computer 402 to provide a user interface to the computer 402. These terminals 420, which are able to be non-intelligent or fully programmable workstations, are used to allow system administrators and users to communicate with the thin client. The terminal 420 is also able to be user interface and peripheral devices that are connected to computer 402 and controlled by terminal interface hardware included in the terminal interface 410 that includes video adapters and interfaces for keyboards, pointing devices, and the like.

An operating system, according to this embodiment, is included in the main memory and is a suitable multitasking operating system such as the Linux, UNIX, Windows XP, or Windows Server 2001 operating system. Embodiments of the present invention are able to use any other suitable operating system, or kernel, or other suitable control software. Some embodiments of the present invention utilize architectures, such as an object oriented framework mechanism, that allow instructions of the components of operating system to be executed on any processor located within the client. The network adapter hardware 412 is used to provide an interface to a network 422 such as the wireless communications network 102, wide area network 112, local area network 114, public switched telephone network 116 and the like. Embodiments of the present invention are able to be adapted to work with any data communications connections including present day analog and/or digital techniques or via a future networking mechanism.

Although the exemplary embodiments of the present invention are described in the context of a fully functional computer system, one of ordinary skill in the art will appreciate that embodiments are capable of being distributed as a program product via floppy disk, e.g., floppy disk, CD ROM, or other form of recordable media, or via any type of electronic transmission mechanism.

Process Automating Control of an Application Client

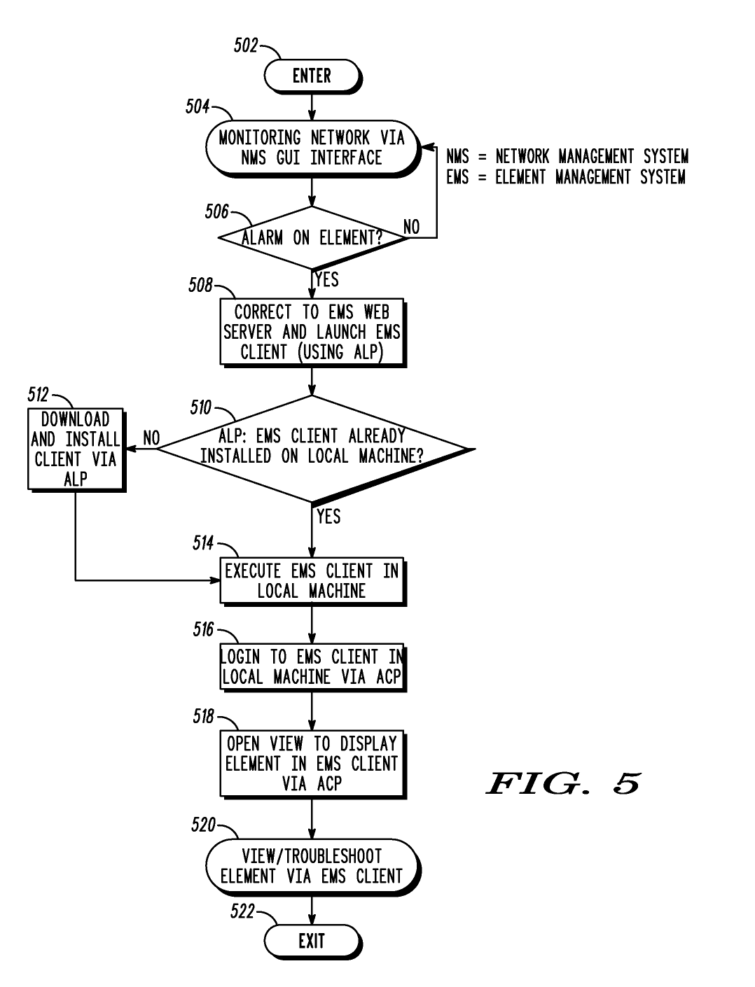

FIG. 5 is an operational diagram illustrating a process of automating control of an application client according to one embodiment of the present invention. The example of FIG. 5 is with respect to a network management system and an element management system. However, the present invention is not limited to such an example. The example of FIG. 5 is applicable both to the wireless communication device 104 and to the client system 110. That is, while the following discussion references the controller module 120 and the application client 124 of the wireless communication device 104, one realizes that the discussion also applies to the controller module 122 and the application client 126 of the client system 110. The operational flow diagram of FIG. 5 begins at step 502 and flows directly to step 504. A user, at step 504, monitors a network via an NMS GUI, e.g., the controller module 120. The controller module 120, at step 506, determines if an event has occurred with a network element. For example, the controller module 120 determines if an event that triggers an alarm associated with a network element has occurred. If the result of this determination is negative, the flow returns to step 504. If the result of this determination is positive, the controller module 120, at step 508, communicates with an EMS web server, such as the web server 128.

For example, the controller module 120, at step 508, connects to the EMS web server for launching an application client (e.g., EMS client) by transmitting an automation launch request 204 via a network protocol language request, e.g., HTTP. The controller module 120, at step 510, determines if an application client 124 (EMS client in this example) associated with the application server 130 (EMS web server in this example) is already installed on the wireless communication device 104. If the result of this determination is negative, the automation launch request 204, at step 512, requests the application client 124 to be downloaded to the user device. The control then flows to step 514. If the result of this determination is positive, the controller module 120, at step 514, initiates the application client 124 by executing the client in the local machine.

The controller module 120, at step 516, logs in to the application client (EMS client) in the wireless communication device 104 via an automation control protocol. For example, the controller module 120, at step 516, transmits an automation control request 206 to the application client for authorizing the user. The controller module 120 via an automation control request 206, at step 518, signals the application client 124 to display a GUI generated by the EMS application, e.g., application server 130, to the user. The GUI displays the network element of interest to the user. The user, at step 520, is then able to interact with the EMS. For example, the user can view/troubleshoot the network element via the application (EMS) client. The control flow then exits at step 522.

The terms “a” or “an”, as used herein, are defined as one or more than one. The term plurality, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “wireless communication device” is intended to broadly cover many different types of devices that can wirelessly receive signals, and optionally can wirelessly transmit signals, and may also operate in a wireless communication system. For example, a wireless communication device can include any one or a combination of the following: a cellular telephone, a mobile phone, a smartphone, a two-way radio, a two-way pager, a wireless messaging device, a laptop/computer, automotive gateway, residential gateway, and the like.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method of automating an application client associated with an application server, the method on wireless communication device comprising:
transmitting, via a controller module, an automation launch request to an application server residing on an information processing system, the automation launch request for initiating an application client associated with the application server;
receiving at least an authorization to initiate the application client from the application server; and
initiating the application client via an automation control request.

2. The method of claim 1, wherein the automation launch request is comprised in a network language protocol request.

3. The method of claim 2, wherein the network language protocol request is a hypertext transfer protocol request.

4. The method of claim 1, wherein the automation control request is comprised in a network language protocol request.

5. The method of claim 4, wherein the network language protocol request is a hypertext transfer protocol request.

6. The method of claim 1, wherein a software platform associated with the controller module is independent of a software platform associated with the application client.

7. The method of claim 1, further comprising:
automatically presenting to a user a graphical user interface for interacting with the application server, wherein the graphical user interface is created by the application server.

8. The method of claim 1, wherein the application client comprises a Java Web Start framework.

9. A method of automating an application client associated with an application server, the method on wireless communication device comprising:
transmitting, via a controller module, an automation launch request comprising a first network language protocol to an application server residing on an information processing system, the automation launch request for initiating an application client associated with the application server;
receiving at least an authorization to initiate the application client from the application server; and
initiating the application client via an automation control request comprising a second network language protocol.

10. The method of claim 9, wherein the first network language protocol is a hypertext transfer protocol.

11. The method of claim 9, wherein the second network language is a Java Web Start protocol.

12. The method of claim 9, further comprising:
receiving at least one graphical user interface generated by the application server; and
providing the at least one graphical user interface to the application client for allowing a user to interact with the application server.

13. A wireless communication device for automating an application client associated with an application server, the wireless communication device comprising:
a memory;
a processor communicatively coupled to the memory;
a controller module communicatively coupled to the memory and the processor, the controller module for:
transmitting an automation launch request to an application server residing on an information processing system, the automation launch request for initiating an application client associated with the application server;
receiving at least an authorization to initiate the application client from the application server; and
initiating the application client via an automation control request.

14. The wireless communication device of claim 13, wherein the automation launch request is comprised in a network language protocol request.

15. The wireless communication device of claim 14, wherein the network language protocol request is a hypertext transfer protocol request.

16. The wireless communication device of claim 13, wherein the automation control request is comprised in a network language protocol request.

17. The wireless communication device of claim 16, wherein the network language protocol request is a hypertext transfer protocol request.

18. The wireless communication device of claim 13, wherein a software platform associated with the controller module is independent of a software platform associated with the application client.

19. The wireless communication device of claim 13, further comprising:
automatically presenting to a user graphical user interface for interacting with the application server, wherein the graphical user interface is created by the application server.

20. The wireless communication device of claim 13, wherein the application client comprises a Java Web Start framework.
